(19) United States
(12) Patent Application Publication
(10) Pub. No.: US 2011/0304814 A1
(43) Pub. Date: Dec. 15, 2011

(54) DOUBLE-PRONGED FLEX HINGE MECHANISM FOR EYEGLASSES TEMPLE ARMS

(75) Inventor: Sze Tung Wong, Kowloon (HK)

(73) Assignee: Eagle International (Industrial) Ltd., Sanpokong (HK)

(21) Appl. No.: 13/159,206

(22) Filed: Jun. 13, 2011

(30) Foreign Application Priority Data
Jun. 13, 2010 (CN) ZL201020236862.1

(51) Int. Cl. G02C 5/22

(52) U.S. Cl. 351/153

(57) ABSTRACT

The present invention enclosure a double-pronged flex hinge mechanism for eyeglasses frames, provide a safe, reliable, and easy to produce double-pronged flex hinge mechanism for eyeglasses temple arms. A double-pronged flex hinge mechanism comprising a temple arm, provided with a flat spring at one end. The end of said flat spring has a notch, which hooks onto the axle in the connecting members. The other end of said connecting member is attached to the end piece of the front frame of the eyeglasses. The present invention is very convenient in the assembly, high efficiency, reliable and durable.

### CROSS-REFERENCE TO RELATED APPLICATIONS

The present application claims priority to Chinese Utility Model Application No. ZL2010 2 0236862.1, filed Jun. 13, 2010, the entirety of which is incorporated herein by reference.

### FIELD OF THE INVENTION

The present invention relates to a glasses frame, specifically, a double-pronged flex hinge mechanism for eyeglasses frames.

### BACKGROUND OF THE INVENTION

Most of the modern glasses frames are made of metal with titanium alloys being used for high-end ones. In most of the modern glasses frames, screws are used in hinges which serve for connecting the frame fronts to the temples. Screws, which are vital in the articulation of the frame front and the temples, can easily get loose and fell out, resulting in repair of the glasses before they can be used again and causing inconvenience to the users. Poor in design and technologically backward, the connecting members, which serve for attaching temple arms to frame fronts, of most of the existing eyewear require improvement. This poses pressing technological problems for eyewear technicians to solve.

### SUMMARY OF THE INVENTION

The present invention is thus to provide a double-pronged flex hinge mechanism for eyeglasses temple arms that can solve the abovementioned technological problems that cause inconvenience to users because of outdated design of the connecting member that retains the temple arms to the frame front. The present invention is safe, reliable, and easy to produce.

To achieve the abovementioned technological goals, the present invention features the following technological innovations:

A double-pronged flex hinge mechanism comprising a temple arm, provided with a flat spring at one end. The end of said flat spring has a notch, which hooks onto the axle in the connecting members. The other end of said connecting member is attached to the end piece of the front frame of the eyeglasses.

There are two said flat springs. An axle exits in said connecting member. Said axle passes through the entire connecting member and extends to the two sides of the connecting member. The notches of the two flat springs hook onto the axle at the two sides of the connecting member.

There are two said connecting members, in between them an axle exists. There are two said flat springs. The notches of two said flat springs hook onto the axle between two connecting members.

There are two said connecting members, in between them an axle exists. There is one said flat springs. The notch of said flat spring hooks onto the axle between two connecting members.

There are two said flat springs. Said connecting member features a wider slot, in which there is an axle. The notches of the two flat spring hook onto the axle inside the slot.

Said connecting member features a slot, in which there is an axle. The notch of a flat spring hook onto the axle in the slot.

Said connecting member features a groove in the side that connects with the end piece of the frame front.

With the present invention, the hinge mechanism connecting the temple arm and the frame front of a pair of eyeglasses can be folded and unfolded by means of the angular rotation of the connecting member and the flat spring of the temple arm.

The present invention can be easily assembled without any screws. Simple in structure, cleverly designed, and easy to produce, it makes fast and efficient production possible. It is also durable and reliable.

### BRIEF DESCRIPTION OF THE DRAWINGS

FIG. 1 is a schematic perspective view of the hinge mechanism according to embodiment 1 of the present invention.

FIG. 2 is a schematic perspective view of the connecting member of the preferred embodiment of the present invention.

FIG. 3 is a schematic perspective view of the flat spring of the preferred embodiment of the present invention.

FIG. 4 is a schematic perspective view of the hinge mechanism according to embodiment 2 of the present invention.

FIG. 5 is a schematic perspective view of the hinge mechanism according to embodiment 3 of the present invention.

FIG. 6 is a schematic perspective view of the hinge mechanism according to embodiment 4 of the present invention.

FIG. 7 is a schematic perspective view of the hinge mechanism according to embodiment 5 of the present invention.

FIG. 8 is a schematic perspective view of the hinge mechanism according to embodiment 6 of the present invention.

### DETAILED DESCRIPTION OF THE INVENTION

The present invention is explained in detail hereinafter with reference to the drawings. It is to be understood that the explanatory embodiment is illustrative and not restrictive of the invention. FIG. 3 shows the structure of the flat spring 104 of the invention.

### Embodiment 1

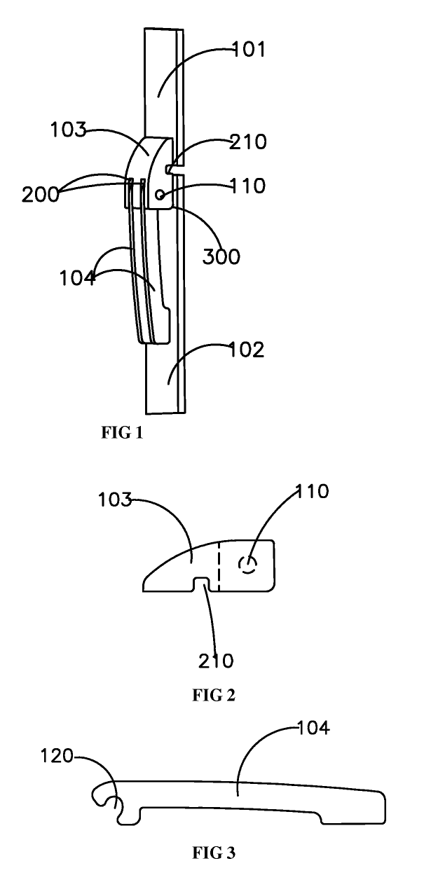

As shown in FIGS. 1 to 3, the double-pronged flex hinge mechanism for eyeglasses comprises a temple arm 102. An end of said temple arm 102 features two flat springs 104. There is a notch at the end part of the flat spring 104. Said notch 120 hooks onto an axle 110 through a slot 200 on the connecting member 103. Said connecting member 103 has two slots 200, which are meant for the two flat springs 104. The term ‘double pronged’ refers to these two flat springs. The axle 110 passes through the two slots 200 and is fixed on the connecting member 103. The other end of said connecting member 103 is attached to the end piece 101 of the frame front of a eyeglasses frame. The side of said connecting member 103 attached to the end piece 101 features a groove 210. The space created by the groove 210 is a buffer for temple arm 102 when it is opening.

When the eyeglasses are in use, the hinge mechanism (as shown as 300 in the figure) connecting the temple arm 102 and the connecting member 103 allows angular rotation, thereby achieving folding and unfolding movements of the temple arm 102.

### Embodiment 2

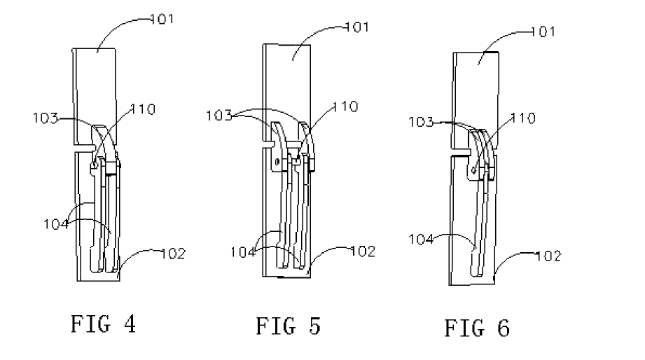

As shown in FIG. 4, the double-pronged flex hinge mechanism for eyeglasses comprises a temple arm 102. An end of said temple arm 102 features two flat springs 104. There is a notch at the end part of the flat spring 104. The connecting member 103 has an axle 110. Said axle 110 passes through the connecting member 103 and extends to the two sides of the connecting member 103. The notches of the two flat springs 104 hook onto the axle 110 at the two sides of the connecting member 103. The other end of the connecting member 103 is attached to the end piece 101 of the frame front of the eyeglasses.

### Embodiment 3

As shown in FIG. 5, the double-pronged flex hinge mechanism for eyeglasses comprises a temple arm 102. An end of said temple arm 102 features flat springs 104. There is a notch at the end part of the flat spring 104. There are two connecting members 103, in between them exists an axle 110. There are two flat springs 104. The notches of the two flat springs 104 hook onto the axle between the two connecting members 103, in between them exists an axle 110. The other end of the connecting member 103 is attached to the end piece 101 of the front frame of the eyeglasses.

### Embodiment 4

As shown in FIG. 6, the double-pronged flex hinge mechanism for eyeglasses comprises a temple arm 102. An end of said temple arm 102 features a flat spring 104. There is a notch at the end part of the flat spring 104. There are two connecting members 103, in between them exists an axle 110. There is one flat spring 104. The notch of said flat spring 104 hooks onto the axle 110 in between the two connecting members 103. The other end of the connecting member 103 is attached to the end piece 101 of the front frame of the eyeglasses.

### Embodiment 5

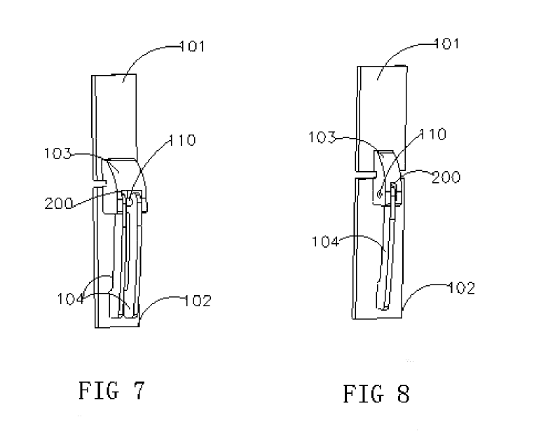

As shown in FIG. 7, the double-pronged flex hinge mechanism for eyeglasses comprises a temple arm 102. An end of said temple arm 102 features two flat springs 104. There is a notch at the end part of the flat spring 104. The connecting member 103 features a wider slot 200, wherein an axle 110 exists. The notches of the two flat springs 104 hook onto the axle 110, which is inside the slot 200. The other end of the connecting member 103 is attached to the end piece 101 of the front frame of the eyeglasses.

### Embodiment 6

As shown in FIG. 8, the double-pronged flex hinge mechanism for eyeglasses comprises a temple arm 102. An end of said temple arm 102 features a flat spring 104. There is a notch at the end part of the flat spring 104. The connecting member 103 features a slot 200, wherein an axle 110 exists. The notch of the flat spring 104 hooks onto the axle 110, which is inside the slot 200. The other end of the connecting member 103 is attached to the end piece 101 of the front frame of the eyeglasses.

All in all, the present invention does not require any screws. The production of it is fast, easy and efficient. It is a reliable and durable product with practical and innovative design.

1. A double-pronged flex hinge mechanism for eyeglasses, comprising:
a temple arm, which has an end provided with a flat spring;
an end part of said flat spring featuring a notch, which hooks onto an axle at a connecting member; and
an other end of said connector attaching to the end piece of the frame front of the eyeglasses.

2. The double-pronged flex hinge mechanism for eyeglasses temple arms as claimed in claim 1, wherein said two flat springs have two notches, which hook onto the axle through two slots on said connecting member.

3. The double-pronged flex hinge mechanism for eyeglasses temple arms as claimed in claim 1, wherein there are two said flat springs;
an axle exits in said connecting member
said axle passes through the entire connecting member and extends to the two sides of the connecting member; and
the notches of the two flat springs hook onto the axle at the two sides of the connecting member.

4. The double-pronged flex hinge mechanism for eyeglasses temple arms as claimed in claim 1, wherein there are two said connecting members, in between them exists an axle; and
two said flat springs;
wherein the notches of two said flat springs hook onto the axle between two connecting members.

5. The double-pronged flex hinge mechanism for eyeglasses temple arms as claimed in claim 1, wherein there are two said connecting members, in between them exists an axle; and
one said flat spring;
wherein the notch of said flat spring hooks onto the axle in between the two connecting members.

6. The double-pronged flex hinge mechanism for eyeglasses temple arms as claimed in claim 1, wherein there are two flat springs;
said connecting member features a wider slot, in which there is an axle;
wherein he notches of the two flat springs hook onto the axle inside the slot.

7. The double-pronged flex hinge mechanism for eyeglasses temple arms as claimed in claim 1, wherein said connecting member features a slot, in which there is an axle;
wherein the notch of a flat spring hooks onto the axle in the slot.

8. The double-pronged flex hinge mechanism for eyeglasses temple arms as claimed in claim 1, wherein said connecting member features a groove in the side that connects with the end piece of the frame front of the eyeglasses.
